(19) United States
(12) Patent Application Publication
(10) Pub. No.: US 2020/0087452 A1
(43) Pub. Date: Mar. 19, 2020

(54) LOW ODOR POLYETHER POLYOL AND PREPARATION THEREOF

(71) Applicant: COVESTRO DEUTSCHLAND AG, Leverkusen (DE)

(72) Inventors: Chenxi ZHANG, Pudong Shanghai (CN); Erika ZHU, Hongkou, Shanghai (CN); Liang XUE, Groningen (NL)

(21) Appl. No.: 16/467,353

(22) PCT Filed: Dec. 4, 2017
(86) PCT No.: PCT/EP2017/081371

§ 371 Date: Jun. 6, 2019

(30) Foreign Application Priority Data
Dec. 6, 2016 (CN) 201611156854.4

(51) Int. Cl. C08G 65/30; C08G 18/48; C08G 18/76; C08G 18/32; C08G 18/66

(52) U.S. Cl. CPC C08G 65/30; C08G 18/4829; C08G 18/6603; C08G 18/3231; C08G 18/7621

(57) ABSTRACT

The present invention relates to a method for the preparation of a low odor polyether polyol, including: a) providing a basic polyether polyol which comprises one or more aldehyde compounds in an amount of lower than 2 wt. %, based on the amount of said basic polyether polyol as 100 wt. %; b) adding to said basic polyether polyol an aldehyde trapping agent and said aldehyde trapping agent is reacted with said one or more aldehyde compounds to remove said one or more aldehyde compounds, wherein said aldehyde trapping agent is in an amount of 0.1 to 5 wt. %, based on the weight of said basic polyether polyol as 100 wt. %; and c) removing the excess aldehyde trapping agent to obtain said low odor polyether polyol. The present invention also relates to the low odor polyether polyol prepared by said method.

### TECHNICAL FIELD

The present invention relates to a low odor polymeric polyol. Aldehyde compounds are removed from said polyol, and thus the polyol has a relatively low odor. In another aspect, the present invention relates to a method for preparing said polymeric polyol.

### BACKGROUND TECHNOLOGY

Odor of a polyether polyol is mainly from the substances which are about 2% by weight, mainly including formaldehydes, acetaldehydes, propionaldehydes, and acetal compounds synthesized by reaction of aldehydes: trioxane, dioxolane, dioxane, allyl alcohol and mono-, di- and tri-propylene glycol allyl esters, etc. Although substances having odor are often in small amounts, they result in undesired odor in polyether polyol.

There have been many mature methods in industry to address the odor problem of polyether polyol, for example, by purification methods like distillation, rectification and water washing, etc, the odor of polyether polyol can be reduced partially but not significantly or eliminated completely. As long as there are minor substances having odor, human will smell the odor of polyether.

Many methods of purifying polyether have been developed in chemical industry both domestic and abroad to remove the side-products produced during production that do not meet requirements from basic polyether polyol. For example, DE-A 2755089 discloses a method of eliminating strong odor side-products, which in particular relates to removing a small amount of water and solvents as well as low molecular weight diols and substances having strong odors with a apiral tube evaporator.

Japanese patent application JP56/104936 discloses a method of purifying polyether polyol, wherein, under a condition where pH>6.5, 1) basic polyether polyol is evaporated under reduced pressure at a high temperature, or 2) similarly, water or nitrogen gas passes through crude polyether polyol under reduced pressure and high temperature.

U.S. patent application U.S. Pat. No. 5,672,768 discloses a method of purifying basic polyether polyol, including purifying basic polyether polyol at a temperature of about 110 to 150° C. and a pressure of about 10 to 70 MPa, wherein water which is about 5 to 30.0% by weight based on the basic polyether polyol is metered to pass through the polyether polyol to be purified over about 1 to 5 hours, and the metered water is in a form of finely divided and dispersed droplets with diameters of about 5 to 100μm.

### BRIEF DESCRIPTION OF THE INVENTION

In an aspect, the present invention provides a method for the preparation of a low odor polyether polyol, including:

a) providing a basic polyether polyol comprising one or more aldehyde compounds in an amount of lower than 2 wt. %, based on the amount of said basic polyether polyol as 100 wt. %;

b) adding an aldehyde trapping agent to said basic polyether polyol and reacting said aldehyde trapping agent with said one or more aldehyde compounds to remove said one or more aldehyde compounds, wherein said aldehyde trapping agent is used in an amount of 0.1 to 5 wt. %, based on the amount of said basic polyether polyol as 100 wt. %; and

c) removing the excess aldehyde trapping agent to obtain said low odor polyether polyol.

In some embodiments of the present invention, said polyether polyol is selected from the group consisting of polyether polyols based on ethylene oxide or propylene oxide.

In some other embodiments of the present invention, said aldehyde compounds are selected from the group consisting of monomeric aldehyde compounds, condensates of monomeric aldehyde compounds, the reaction products of monomeric aldehyde compounds and diols.

In some further embodiments of the present invention, said aldehyde trapping agent is selected from the group consisting of hydrazine compounds or salts thereof, and their solvates.

In some further embodiments of the present invention, said hydrazine compounds are selected from the group consisting of hydrazine, carbamyl hydrazine, carbohydrazide, oxamic hydrazide, oxalyldihydrazide, propanedioyl dihydrazide, butanedioyl dihydrazide or combinations thereof.

In some further embodiments of the present invention, in said step b), the aldehyde trapping agent is reacted with the aldehyde compound(s) at a temperature of 40 to 130° C. for 1 to 5 hours.

In some further embodiments of the present invention, the reaction between the aldehyde trapping agent and the aldehyde compound(s) is carried out in an inert gas atmosphere.

In some further embodiments of the present invention, in said step c), said aldehyde trapping agent is removed by adding and reacting an isocyanate with said unreacted aldehyde trapping agent.

In some further embodiments of the present invention, said isocyanate is selected from the group consisting of toluene diisocyanate, diphenylmethane diisocyanate, or combinations thereof.

In another aspect, the present invention relates to a low odor polyether polyol prepared by the method as described above.

In a further aspect, the present invention relates to a polyurethane material prepared from the low odor polyether polyol as described above.

### DETAILED DESCRIPTION OF THE INVENTION

In an aspect, the present invention provides a method for the preparation of a low odor polyether polyol, including:

a) providing a basic polyether polyol comprising one or more aldehyde compounds in an amount of lower than 2 wt. %, based on the amount of said basic polyether polyol as 100 wt. %; and

b) adding an aldehyde trapping agent to said basic polyether polyol and reacting said aldehyde trapping agent with said one or more aldehyde compounds to remove said one or more aldehyde compounds, wherein said aldehyde trapping agent is used in an amount of 0.1 to 5 wt. %, based on the amount of said basic polyether polyol as 100 wt. %; and

c) removing the excess aldehyde trapping agent to obtain said low odor polyether polyol.

The present invention is accomplished by adding an aldehyde trapping agent to a basic polyether polyol, in which said aldehyde trapping agent can react with aldehyde compounds that may result in unpleasant odor, so that said compounds can be removed to produce a low odor polymeric polyol product.

As used herein, said basic polyether polyol refers to prepared crude products of polyether polyol, i.e., the crude products prepared by the reaction of an olefin oxide and an initiator in the presence of a catalyst. Said catalyst is preferably, but not limited to, alkaline hydroxide, alkaline alkoxide, antimony pentachloride, boron fluoride etherate, or a mixture thereof. Said olefin oxide is preferably, but not limited to, tetrahydrofuran, ethylene oxide, propylene oxide, 1,2-butylene oxide, 2,3-butylene oxide, styrene oxide, or a mixture thereof, particularly preferably ethylene oxide and/or propylene oxide, i.e. said basic polyether polyol is selected from the group consisting of polyether polyols based on ethylene oxide or propylene oxide. Said initiator is preferably, but not limited to, a polyhydroxy compound or a polyamino compound. Said polyhydroxy compound is preferably, but not limited to, water, ethylene glycol, 1,2-propanediol, 1,3-propanediol, diethylene glycol, trimethylolpropane, glycerol, bisphenol A, bisphenol S or a mixture thereof. Said polyamino compound is preferably, but not limited to, ethylenediamine, propanediamine, butanediamine, hexanediamine, diethylene triamine, toluenediarnine, or a mixture thereof.

In the process for preparing the basic polyether polyol, aldehyde compounds may not only be comprised in the raw materials, in particular the olefin oxide, as impurities, but also be produced during the reaction process, so that the polyether polyol produced may have a strong odor. Generally, said basic polyether polypl comprises aldehyde compounds in an amount of lower than 2 wt. %, based on the amount of said basic polyether polyol as 100 wt. %.

As used herein, the aldehyde compounds include monomeric aldehyde compounds, condensates of monomeric aldehyde compounds, and reaction products of monomeric aldehyde compounds and diols. Said monomeric aldehyde compounds are, for example, but not limited to formaldehydes, acetaldehydes, propionaldehydes, butyraldehyde, and acrylaldehyde. Said condensates are, for example, but not limited to 2,4,6-triethyl-1,3,5-trioxane. The reaction products of monomeric aldehyde compounds and dials are, for example, but not limited to trioxacyclooctane. In the present application, said aldehyde compounds also include ketone compounds that are able to react with the aldehyde trapping agent. In some embodiments of the present invention, said aldehyde compounds are selected from the group consisting of formaldehyde, acetaldehyde, propionaldehyde, butyraldehyde, acrylaldehyde, trioxacyclooctane, and 2,4,6-triethyl-1,3,5-trioxane.

In an embodiment of the present invention, said basic polyether polyol can be a commercially available polyether polyol product, or a crude product prepared in a laboratory.

After the basic polyether polyol is obtained, an aldehyde trapping agent is added to said basic polyether polyol, and said aldehyde trapping agent is then reacted with one or more aldehyde compounds under certain conditions to remove said one or more aldehyde compounds.

As used herein, the aldehyde trapping agent refers to a substance that can chemically or physically react with the above-mentioned aldehyde compounds to remove them. In some preferred embodiments of the present invention, said aldehyde trapping agent is selected from the group consisting of hydrazine compounds or salts thereof, and their solvates. More preferably, said hydrazine compounds are selected from the group consisting of hydrazine, carbamyl hydrazine, carbohydrazide, oxamic hydrazide, oxalyldihydrazide, propanedioyl dihydrazide, butanedioyl dihydrazide or combinations thereof. In some embodiments of the present invention, examples of the salts of hydrazine compounds include, but are not limited to, hydrochlorides, sulfates, phosphates, and tartrates. Solvates of said hydrazine compounds and salts thereof include, but are not limited to, hydrates, ethanolates, and diethanolates, particularly preferably hydrates.

In some embodiments of the present invention, said aldehyde trapping agent is used in an amount of 0.1 to 5 wt. %, preferably 1 to 3 wt %, and most preferably 1 to 2 wt%, based on the total weight of said basic polyether polyol as 100 wt. %.

The aldehyde trapping agent is reacted with the aldehyde compounds under certain conditions. In some preferred examples of the present invention, the aldehyde trapping agent is added to the basic polyether polyol, and the reaction mixture is refluxed at a temperature of 40 to 130° C., preferably 80 to 110° C., for 1 to 5 hours to remove the aldehyde compounds from the basic polyether polyol. In some preferred embodiments of the present invention, said reaction is carried out in an inert gas atmosphere, and said inert gas is preferably nitrogen. In some other preferred embodiments of the present invention, the reaction product is washed with water after the completion of the reaction.

In an embodiment of the present invention, an excessive amount of the aldehyde trapping agent is reacted with the aldehyde compounds, and thus, after the completion of the reaction, the excess aldehyde trapping agent has to be removed. In a preferred embodiment of the present invention; said aldehyde trapping agent is selected from the group consisting of hydrazine compounds or salts thereof, and their solvates, the excess hydrazine compounds can be removed by the reaction with isocyanate, and the resulting solids like polyurea and/or polybiurea can be retained in the polyether polyol product.

In some embodiments of the present invention, said isocyanate is selected from the group consisting of toluene diisocyanate, diphenylmethane diisocyanate, or combinations thereof. Said isocyanate is preferably added in an amount equivalent in mole to the aldehyde trapping agent. In some embodiments of the present invention, the resulting solids like polyurea and/or polybiurea are present in an amount of 2 to 20 wt %, preferably 3 to 15 wt %.

After the excess aldehyde trapping agent is removed, the resulting polymeric polypi can be further treated, for example by dehydration, so as to produce a low odor polymeric polyol product.

In some embodiments of the present invention, the polyether polyol treated with isocyanate is dehydrated at 110 to 130° C. and a vacuum degree of 20 to 50 Pa so as to produce a low odor polyether polyol.

In another aspect, the present invention provides a low odor polyether polyol prepared by the above method. In some embodiments of the present invention, said low odor polyether polyol is selected from the group consisting of polyether polyols based on ethylene oxide or propylene oxide. In some other embodiments of the present invention, said low odor polyether polyol has a functionality of 2 to 6, and a hydroxyl value from 50 to 500 mg KOH/g.

In a further aspect, the present invention relates to a polyurethane material prepared from the above low odor polyether polyol. Said polyurethane material can be selected from the group consisting of flexible polyurethane foam, rigid polyurethane foam, polyurethane elastomers, polyurethane composites, and the like.

In a first embodiment the invention is related to a method for a preparation of a polyether polyol, preferably of a low odor polyether polyol, comprising:

a) providing a basic polyether polyol comprising one or more aldehyde compounds in an amount of lower than 2 wt. %, based on the amount of said basic polyether polyol as 100 wt. %;

b) adding an aldehyde trapping agent to said basic polyether polyol and reacting said aldehyde trapping agent with said one or more aldehyde compounds to remove said one or more aldehyde compounds, wherein said aldehyde trapping agent is used in an amount of 0.1 to 5 wt. %, based on the amount of said basic polyether polyol as 100 wt. %; and

c) removing the excess aldehyde trapping agent to obtain said low odor polyether polyol.

In a second embodiment the invention is related to the method for the preparation of a polyether polyol, preferably of low odor polyether polyol, according to first embodiment, wherein said basic polyether polyol is selected from the group consisting of polyether polyols based on ethylene oxide or propylene oxide.

In a third embodiment the invention is related to the method for the preparation of a polyether polyol, preferably of a low odor polyether polyol, according to the first or second embodiment, wherein said aldehyde compounds are selected from the group consisting of monomeric aldehyde compounds, condensates of monomeric aldehyde compounds, and products from reaction of monomeric aldehyde compounds and diols.

In a fourth embodiment the invention is related to the method for the preparation of a polyether polyol, preferably of a low odor polyether polyol, according to one of the first to third embodiment, wherein said aldehyde trapping agent is selected from the group consisting of hydrazine compounds or salts thereof, and their solvates.

In a fifth embodiment the invention is related to the method for the preparation of a polyether polyol, preferably of a low odor polyether polyol, according to the fourth emodiment, wherein said hydrazine compounds are selected from the group consisting of hydrazine, carbamyl hydrazine, carbohydrazide, oxamic hydrazide, oxalyldihydrazide, propanedioyl dihydrazide, butanedioyl dihydrazide or combinations thereof.

In a sixth embodiment the invention is related to the method for the method for the preparation of a polyether polyol, preferably of a low odor polyether polyol, according to one of the first to fifth embodiment, wherein in said step b), the aldehyde trapping agent is reacted with the aldehyde compound(s) at a temperature of 40 to 130° C. for 1 to 5 hours.

In a seventh embodiment the invention is related to the method for the preparation of a polyether polyol, preferably of a low odor polyether polyol, according to the sixth embodiment, wherein the reaction between the aldehyde trapping agent and the aldehyde compound(s) is carried out in an inert gas atmosphere.

In an eighth embodiment the invention is related to the method for the preparation of a polyether polyol, preferably of a low odor polyether polyol, according to one of the first to seventh embodiment, wherein in said step c), said aldehyde trapping agent is removed by adding and reacting an isocyanate with the unreacted aldehyde trapping agent.

In a ninth embodiment the invention is related to the method for the preparation of a polyether polyol, preferably of a low odor polyether polyol, according to the eighth embodiment, wherein said isocyanate is selected from the group consisting of toluene diisocyanate, diphenylmethane diisocyanate, or combinations thereof.

In a tenth embodiment the invention is related to a polyether polyol, preferably of a low odor polyether polyol, wherein said polyether polyol, preferably of a low odor polyether polyol, is prepared by the method according to any one of the first to ninth embodiment.

In an eleventh embodiment the invention is related to a polyurethane material, wherein said polyurethane material is prepared from the polyether polyol, preferably of the low odor polyether polyol, according to the tenth embodiment.

### EXAMPLES

The raw materials used in the Examples of the present application are as follows.

| | | Hydroxyl | |
|---|---|---|---|
| Trade name | Type | value | Source |
| Arcol 3553 | Polyether | 35 | Purchased from Covestro |
| | polyol | | Polymers (China) Company Ltd |
| Arcol 1362 | Polyether | 28 | Purchased from Covestro |
| | polyol | | Polymers (China) Company Ltd |
| TDI T 80 | Toluene | | Purchased from Covestro |
| | diisocyanate | | Polymers (China) Company Ltd |
| Hydrazine | Containing | | Purchased from Aladdin Reagent |
| hydrate | 36% of | | Co., Ltd |
| | water | | |

Method for Testing the Odor of the Polyether Polyol 150 ml of the polyether polyol was placed into 200 ml glass bottles which were placed, respectively, at the room temperature of 25° C. or in an oven of 80° C. for 2 hours. After the bottles were taken out, 8 to 10 persons smelled the above polyether polyol individually with an interval of 10 minutes respectively, and rated the level of the odor according to the standards listed in the following table. The average value of the levels given by each person is taken as the final result.

TABLE 1
Test Standards for the Odor of Polyether Polyol

| Standards for evaluation | Odor levels |
|---|---|
| No odor | 1 |
| Odor without interference | 2 |
| Obvious odor without interference | 3 |
| Odor with interference | 4 |
| Strong odor with interference | 5 |
| Unbearable | 6 |

Result calculation; individual evaluation on odor level can have an accuracy up to 0.5; the final evaluation result is the arithmetic average value of individual evaluation levels, which has an accuracy up to 0.5.

### Examples 1-3

A 1000 ml four-neck reaction bottle was equipped with a temperature tester, a Pendraulik stirrer and an evacuating device. ARCOL 3553 polyether polyol and hydrazine hydrate were added according to the amounts given in the following table. After 2 hours of reaction at 60° C., T-80 was further added dropwise to the mixture under rapid stirring, after which the mixture was stirred for another half an hour. At 100° C., nitrogen was passed through and the bottle was evacuated to remove excess water. After cooling to room temperature, the odor level of the sample was rated. The result is shown in Table 2.

TABLE 2
Test Result of the Odor of Polyether Polyol

| | Comparative | | | |
|---|---|---|---|---|
| | Example 1 | Example 1 | Example 2 | Example 3 |
| Arcol 3553 | 600 | 600 | 600 | 600 |
| Hydrazine | — | 6 | 12 | 18 |
| hydrate (g) | | | | |
| Reaction time at | — | 2 | 2 | 2 |
| 60° C. | | | | |
| T-80 (g) | — | 22.8 | 45.6 | 68.4 |
| Polyether odor | 2.4 | 2.0 | 1.7 | 1.2 |
| at 25° C. | | | | |
| Polyether odor | 2.8 | 2.5 | 1.8 | 1.5 |
| at 80° C. | | | | |

It can be seen from the above Examples that, under sufficient stirring at 60° C., hydrazine hydrate can reduce the odor of the polyether polyol.

### Examples 4-6

A 1000 ml four-neck reaction bottle was equipped with a temperature tester, a Pendraulik stirrer and an evacuating device. ARCOL 1362 polyether polyol and hydrazine hydrate were added according to the amounts given in the following table. After 2 hours of reaction and reflux at 95 to 100° C., T-80 was further added dropwise to the mixture under rapid stirring, after which the mixture was stirred for another half an hour. At 100° C., nitrogen was passed through and the bottle was evacuated to remove excess water. After cooling to room temperature, the odor level of the sample was rated. The result is shown in Table 3.

TABLE 3
Test Result of the Odor of Polyether Polyol

| | Comparative | | | |
|---|---|---|---|---|
| | Example 2 | Example 4 | Example 5 | Example 6 |
| Arcol 1362 | 600 | 600 | 600 | 600 |
| Hydrazine hydrate | — | 12 | | — |
| (g) | | | | |
| Butanedioyl | — | — | 20 | — |
| dihydrazide (g) | | | | |
| Adipyl dihydrazide | — | | | 20 |
| (g) | | | | |
| Reaction time at | — | 2 | 2 | 2 |
| 80° C. (h) | | | | |
| T-80 (g) | — | 45.6 | 45.6 | 45.6 |
| Polyether odor at | 2.7 | 1.3 | 1.7 | 1.8 |
| 25° C. | | | | |
| Polyether odor at | 2.9 | 1.5 | 2.2 | 2.3 |
| 80° C. | | | | |

It can be seen from the above Examples that all of the hydrazine compounds have the effect of reducing the odor of the polyether polyol, but hydrazine hydrate shows the best effect.

### Examples 7-8

### Example 7

### Stepwise Method

A 1000 ml four-neck reaction bottle was equipped with a temperature tester, a Pendraulik stirrer and an evacuating device. 500 g of ARCOL 1362 polyether polyol and 7.5 g of hydrazine hydrate were added according to the amounts given in the following table. After 2 hours of reaction and reflux at 80° C., T-80 (26 g) was further added dropwise to the mixture under rapid stirring, after which the mixture was stirred for another half an hour. At 100° C., nitrogen was passed through and the bottle was evacuated to remove excess water. After cooling to room temperature, the odor level of the sample was rated. The result is shown in Table 4.

### Example 8

### One-Step Method

A 1000 ml four-neck reaction bottle was equipped with a temperature tester, a Pendraulik stirrer and an evacuating device. 500 g of ARCOT, 1362 polyether polyol, 7.5 g of hydrazine hydrate and T-80 (26 g) were added according to the amounts given in the following table. Reaction and reflux were carried out at 80° C. under rapid stirring for 2 hours. Then, at 100° C., nitrogen was passed through and the bottle was evacuated to remove excess water. After cooling to room temperature, the odor level of the sample was rated. The result is shown in Table 4.

TABLE 4
Test Result of the Odor of Polyether Polyol

| | Arcol | | |
|---|---|---|---|
| | 3553 | Example 7 | Example 8 |
| Odor rating at 25° C. | 2.5 | 1.5 | 2.0 |
| Odor rating at 80° C. | 3.0 | 2.5 | 3.0 |

It can be seen from Examples 7-8 that the reaction according to the stepwise method is more complete arid has a better effect in deodorization than that according to the one-step method.

1. A method for the preparation of a low odor polyether polyol, comprising:
a) providing a basic polyether polyol comprising one or more aldehyde compounds in an amount of lower than 2 wt. %, based on the amount of said basic polyether polyol as 100 wt. %;
b) adding an aldehyde trapping agent to said basic polyether polyol and reacting said aldehyde trapping agent with said one or more aldehyde compounds to remove said one or more aldehyde compounds, wherein said aldehyde trapping agent is used in an amount of 0.1 to 5 wt. %, based on the amount of said basic polyether polyol as 100 wt. %; and
c) removing the excess aldehyde trapping agent to obtain said low odor polyether polyol.

2. The method for the preparation of a low odor polyether polyol according to claim 1, wherein said basic polyether polyol is oxide or propylene oxide.

3. The method for the preparation of a low odor polyether polyol according to claim 1, wherein said aldehyde compounds are selected from the group consisting of monomeric aldehyde compounds, condensates of monomeric aldehyde compounds, and products from reaction of monomeric aldehyde compounds and diols.

4. The method for the preparation of a low odor polyether polyol of claim 1, wherein said aldehyde trapping agent is selected from the group consisting of hydrazine compounds or salts thereof, and their solvates.

5. The method for the preparation of a low odor polyether polyol according to claim 4, wherein said hydrazine compounds are selected from the group consisting of hydrazine, carbamyl hydrazine, carbohydrazide, oxamic hydrazide, oxalyldihydrazide, propanedioyl dihydrazide, butanedioyl dihydrazide and combinations thereof.

6. The method for the preparation of a low odor polyether polyol of claim 1, wherein in said step b), the aldehyde trapping agent is reacted with the aldehyde compound(s) at a temperature of 40 to 130° C. for 1 to 5 hours.

7. The method for the preparation of a low odor polyether polyol according to claim 6, wherein the reaction between the aldehyde trapping agent and the aldehyde compound(s) is carried out in an inert gas atmosphere.

8. The method for the preparation of a low odor polyether polyol of claim 1, wherein in said step c), said aldehyde trapping agent is removed by adding and reacting an isocyanate with the unreacted aldehyde trapping agent.

9. The method for the preparation of a low odor polyether polyol according to claim 8, wherein said isocyanate is selected from the group consisting of toluene diisocyanate, diphenylmethane diisocyanate, and combinations thereof.

10. A low odor polyether polyol prepared by the method of claim 1.

11. A polyurethane material prepared from the low odor polyether polyol of claim 10.
